(19) United States
(12) Patent Application Publication
(10) Pub. No.: US 2008/0145825 A1
(43) Pub. Date: Jun. 19, 2008

(54) CALCULATION SYSTEM AND APPARATUS

(75) Inventor: Amy Clark-Wickham, Eagan, MN (US)

Correspondence Address: SCHWEGMAN, LUNDBERG & WOESSNER, P.A., P.O. BOX 2938, MINNEAPOLIS, MN, 55402, US

(73) Assignee: Math Wonders, LLC

(21) Appl. No.: 11/955,146

(22) Filed: Dec. 12, 2007

Related U.S. Application Data
(60) Provisional application No. 60/874,786, filed on Dec. 14, 2006.

(51) Int. Cl. G09B 1/00; A63F 9/06; G05B 19/00

(52) U.S. Cl. 434/196; 273/146; 700/89

(57) ABSTRACT

In an embodiment, an apparatus includes a first perimeter including a facsimile of a clock, a second perimeter including a plurality of fractions, a third perimeter including a plurality of decimal numbers, a fourth perimeter including a plurality of percentages, and a fifth perimeter including a plurality of degree magnitudes. The apparatus is useful in relating one set of information to another set of information.

### RELATED APPLICATIONS

This application claims the priority benefit of U.S. Provisional Application No. 60/874,786, filed on Dec. 14, 2006, which is incorporated herein by reference in its entirety.

### TECHNICAL FIELD

Various embodiments relate to a system and apparatus for teaching.

### BACKGROUND

Throughout time, people, and in particular younger students, have struggled with learning and using fractions and other number representations, and the relationships and conversions among them. While such relationships and conversions can be successfully taught, it is usually a rough road, especially for the younger students.

### BRIEF DESCRIPTION OF THE DRAWINGS

FIG. 1 illustrates an example embodiment of an apparatus configured to aid in operations involving several different numerical types and formats.

FIG. 2 illustrates an example embodiment of a process to teach operations involving several different numerical types and formats.

FIGS. 3A, 3B, 3C, and 3D illustrate examples of playing cards embodied with different numerical expressions.

FIG. 4 illustrates an example embodiment of a computer architecture that can be used in connection with one or more embodiments of the present disclosure.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

One or more figures show block diagrams of systems and apparatus of embodiments of the invention. One or more figures show flow diagrams illustrating systems and apparatus for such embodiments. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

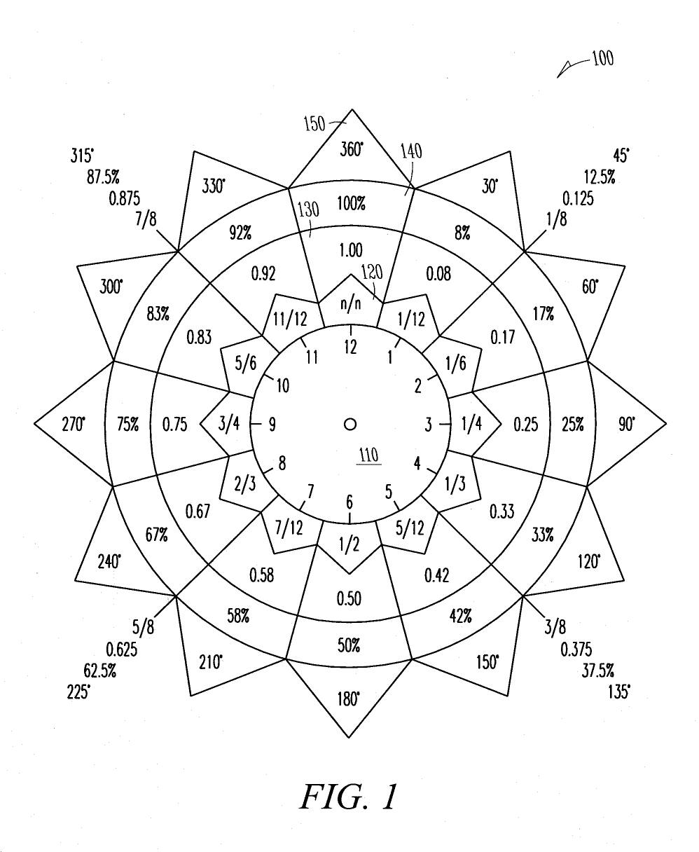

FIG. 1 illustrates an example embodiment of a system and apparatus 100 for calculations involving, and conversions between, several different numerical types and formats. In addition to numerical information, the apparatus 100 can include musical, historical, calendar, temperature, measurement, and language and other literary information as a further example. Moreover, while the apparatus 100 is illustrated in circular form in FIG. 1, other representations are also possible including oval, elliptical, square, and rectangular for example. The apparatus 100 could even take the form of a table of data. The circle, oval, ellipse, square, rectangle, and table all serve as a means to relate one set of information to another set of information, and in particular, 12 or more points of information and multiples thereof. The 12 or more points of information could be referred to as segments of the information. The apparatus 100 includes a first perimeter 110 that is a facsimile of a clock, a second perimeter 120 that includes a plurality of fractions, a third perimeter 130 that includes a plurality of decimal numbers, a fourth perimeter 140 that includes a plurality of percentages, and a fifth perimeter 150 that includes a plurality of degree magnitudes. In the embodiment of FIG. 1, the first, second, third, fourth, and fifth perimeters are concentric. The different perimeters can be interchanged. For example, the fifth perimeter could be associated with percentages and the fourth perimeter could be associated with degree magnitudes.

The apparatus 100 can be manufactured as a ring or a set of interchangeable and combinable rings that fit around a typical analog clock. The ring or rings could be manufactured out of plastic, a magnetic sheet, a “craft” foam sheet, a heavy paper, or other printable material. At each “hour” of the clock, a value is displayed, for example, “¼” on the fraction ring, 0.25 on the decimal ring, 25% on the percent ring, and 90° on the degree ring. In clocks which are deep, that is, which stick out from the wall a few inches, a ring may be fitted to its face using clear nylon thread, connecting the inner ring nearest the clock face to the outer rings further out around the perimeter. The rings may be placed around a clock in a classroom, pertaining to whatever subject the teacher may be focusing upon. They may be used interchangeably or combined, and may be flipped over or covered for testing. The rings provide an opportunity for both active and passive learning of materials, and can serve as a reference for teachers and students. The apparatus 100 could also be manufactured as a multi-piece puzzle.

One or more colors can be used in connection with the clock rings to provide another level of association between patterns of information. For example, the rings or clock could be configured such that ½ is red, ⅓ is yellow, and ¼ is blue. When fractions are combined, or associated, so are the colors. For example, ½ of ⅓ is ⅙ (red and yellow make orange), ½ of ¼ is ⅛ (red and blue make purple), and ⅓ of ¼ is 1/12 (blue and yellow make green). Colors may be used in all subjects, particularly the primary and secondary colors, providing association of any significant patterns in the information on the rings.

In an embodiment, the first perimeter includes a 12:00 position, and the 12:00 position is associated with one or more of a fraction of n/n, a decimal number 1.00, a percentage of 100%, and a 360 degree magnitude. The fraction, decimal number, percentage, and degree magnitude may be included in one or more of the second perimeter, the third perimeter, the fourth perimeter, and the fifth perimeter.

In an embodiment, the first perimeter includes a 1:00 position, and the 1:00 position is associated with one or more of a fraction of 1/12, a decimal number 0.08, a percentage of 8%, and a 30 degree magnitude. The fraction, decimal number, percentage, and degree magnitude may be included in one or more of the second perimeter, the third perimeter, the fourth perimeter, and the fifth perimeter.

In an embodiment, the first perimeter includes a 2:00 position, and the 2:00 position is associated with one or more of a fraction of ⅙, a decimal number 0.17, a percentage of 17%, and a 60 degree magnitude. The fraction, decimal number, percentage, and degree magnitude may be included in one or more of the second perimeter, the third perimeter, the fourth perimeter, and the fifth perimeter.

In an embodiment, the first perimeter includes a 3:00 position, and the 3:00 position is associated with one or more of a fraction of ¼, a decimal number 0.25, a percentage of 25%, and a 90 degree magnitude. The fraction, decimal number, percentage, and degree magnitude may be included in one or more of the second perimeter, the third perimeter, the fourth perimeter, and the fifth perimeter.

In an embodiment, the first perimeter includes a 4:00 position, and the 4:00 position is associated with one or more of a fraction of ⅓, a decimal number 0.33, a percentage of 33%, and a 120 degree magnitude. The fraction, decimal number, percentage, and degree magnitude may be included in one or more of the second perimeter, the third perimeter, the fourth perimeter, and the fifth perimeter.

In an embodiment, the first perimeter includes a 5:00 position, and the 5:00 position is associated with one or more of a fraction of 5/12, a decimal number 0.42, a percentage of 42%, and a 150 degree magnitude. The fraction, decimal number, percentage, and degree magnitude may be included in one or more of the second perimeter, the third perimeter, the fourth perimeter, and the fifth perimeter.

In an embodiment, the first perimeter includes a 6:00 position, and the 6:00 position is associated with one or more of a fraction of ½, a decimal number 0.50, a percentage of 50%, and a 180 degree magnitude. The fraction, decimal number, percentage, and degree magnitude may be included in one or more of the second perimeter, the third perimeter, the fourth perimeter, and the fifth perimeter.

In an embodiment, the first perimeter includes a 7:00 position, and the 7:00 position is associated with one or more of a fraction of 7/12, a decimal number 0.58, a percentage of 58%, and a 210 degree magnitude. The fraction, decimal number, percentage, and degree magnitude may be included in one or more of the second perimeter, the third perimeter, the fourth perimeter, and the fifth perimeter.

In an embodiment, the first perimeter includes an 8:00 position, and the 8:00 position is associated with one or more of a fraction of ⅔, a decimal number 0.67, a percentage of 67%, and a 240 degree magnitude. The fraction, decimal number, percentage, and degree magnitude may be included in one or more of the second perimeter, the third perimeter, the fourth perimeter, and the fifth perimeter.

In an embodiment, the first perimeter includes a 9:00 position, and the 9:00 position is associated with one or more of a fraction of ¾, a decimal number 0.75, a percentage of 75%, and a 270 degree magnitude. The fraction, decimal number, percentage, and degree magnitude may be included in one or more of the second perimeter, the third perimeter, the fourth perimeter, and the fifth perimeter.

In an embodiment, the first perimeter includes a 10:00 position, and the 10:00 position is associated with one or more of a fraction of ⅚, a decimal number 0.83, a percentage of 83%, and a 300 degree magnitude. The fraction, decimal number, percentage, and degree magnitude may be included in one or more of the second perimeter, the third perimeter, the fourth perimeter, and the fifth perimeter.

In an embodiment, the first perimeter includes an 11:00 position, and the 11:00 position is associated with one or more of a fraction 11/12, a decimal number 0.92, a percentage of 92%, and a 330 degree magnitude. The fraction, decimal number, percentage, and degree magnitude may be included in one or more of the second perimeter, the third perimeter, the fourth perimeter, and the fifth perimeter.

In an embodiment, the first perimeter includes a 1:30 position, and the 1:30 position is associated with one or more of a fraction of ⅛, a decimal number 0.125, a percentage of 12.5%, and a 45 degree magnitude. The fraction, decimal number, percentage, and degree magnitude may be included in one or more of the second perimeter, the third perimeter, the fourth perimeter, and the fifth perimeter.

In an embodiment, the first perimeter includes a 4:30 position, and the 4:30 position is associated with one or more of a fraction of ⅜, a decimal number 0.375, a percentage of 37.5%, and a 135 degree magnitude. The fraction, decimal number, percentage, and degree magnitude may be included in one or more of the second perimeter, the third perimeter, the fourth perimeter, and the fifth perimeter.

In an embodiment, the first perimeter includes a 7:30 position, and the 7:30 position is associated with one or more of a fraction of ⅝, a decimal number 0.625, a percentage of 62.5%, and a 225 degree magnitude. The fraction, decimal number, percentage, and degree magnitude may be included in one or more of the second perimeter, the third perimeter, the fourth perimeter, and the fifth perimeter.

In an embodiment, the first perimeter includes a 10:30 position, and the 10:30 position is associated with one or more of a fraction of ⅞, a decimal number 0.875, a percentage of 87.5%, and a 315 degree magnitude. The fraction, decimal number, percentage, and degree magnitude may be included in one or more of the second perimeter, the third perimeter, the fourth perimeter, and the fifth perimeter.

As will be explained in detail herein, the apparatus 100 can be configured to permit conversion between the fractions, the decimal numbers, the percentages, and the degree magnitudes, and to permit mathematical operations among the fractions, the decimal numbers, the percentages, and the degree magnitudes. The mathematical operations can include, for example, addition, subtraction, multiplication, and division.

The apparatus 100 can be used for teaching equivalent facts or patterns using an analog clock as a circular, twelve-point progression and as a basis for various conversions. Additionally, the use of colors can be incorporated to enhance associations or patterns within the displayed information. Its use is primarily for, but not limited to, mathematical conversions, such as in connection with fractions, decimals, percents, and degrees. However, the apparatus 100 may also be configured to relate information involving, but is not limited to, currency, measurements, language, temperature, historical facts, months, literary information, radians, trigonometric functions, modular arithmetic, factorials, square roots, exponentials, logarithms, or musical keys and chords. This information can be placed in any perimeter of the apparatus 100 of FIG. 1, and more perimeters could be added to the apparatus 100 of FIG. 1. For example, the perimeter 130 containing decimal numbers could be replaced with historical facts, arranged for example, on a timeline, and the perimeter 140 containing percentages could be replaced with trigonometric functions. Each set of information can be accompanied by exercises, games and activities to deepen the understanding of material.

When radian information is added to the apparatus 100, the apparatus can be configured so that the 12:00 position relates to 2π, the 1:00 position relates to π/6, the 2:00 position relates to π/3, the 3:00 position relates to π/2, the 4:00 position relates to 2π/3, the 5:00 position relates to 5π/6, the 6:00 position relates to π, the 7:00 position relates to 7π/6, the 8:00 position relates to 4π/3, the 9:00 position relates to 3π/2, the 10:00 position relates to 5π/3, the 11:00 position relates to 11π/6, the 1:30 position relates to π/4, the 4:30 position relates to 3π/4, the 7:30 position relates to 5π/4, and the 10:30 position relates to 7π/4.

An example of exponential information that could be added to the apparatus 100 includes exponential powers of 2, wherein the 1:00 position relates to 2, the 2:00 position relates to 4, the 3:00 position relates to 8, the 4:00 position relates to 16, the 5:00 position relates to 32, the 6:00 position relates to 64, the 7:00 position relates to 128, the 8:00 position relates to 256, the 9:00 position relates to 512, the 10:00 position relates to 1024, the 11:00 position relates to 2048, and the 12:00 position relates to 4096 (and 1). Such an embodiment would be particularly useful in the computer sciences. Similarly, the apparatus 100 can include a perimeter that includes modular arithmetic, and in particular, increments of 12 such that for example the 3:00 position would be 3, then 15, then 27, then 39, etc. Pyramid (or triangular) numbers could relate the 3:00 position to the number 6 (i.e., 3+2+1), factorials could relate the 3:00 position to the number 6 (3×2×1), and for exponents, the 3:00 position could be related to the numbers 3, 9, 27, 81, etc. Similarly, the 12 (or more) clock positions could be related to the square roots of those positions (e.g., 9:00 would be related to the number 3). For the trigonometric functions for example, the 3:00 position could be related to the cosine (or other trigonometric function) of 7π/2 or 90° (since the 3:00 position is associated with 7π/2 or 90°) and 0 (i.e., the cosine of 7π/2 or 90°).

Referring to FIG. 1, the hours on the apparatus or clock 100 are marked with the numbers 1 through 12. When the clock 100 indicates that it is 6:00, the two hands make a straight line across the center of the clock, dividing the circle in half. It could therefore be stated that 6:00 is one-half, or ½. It could also be stated that the hour hand has gone past 6 out of 12 hours, or 6/12 of the whole way around. When the clock 100 indicates 3:00, a quarter circle is the result. It can be automatically recognized that 3 out of 12, or 3/12, is equal to ¼. When the clock 100 indicates 9:00, it is 9/12 of the whole way around, which is the same as ¾.

In another embodiment, when the clock 100 is divided into three sections, the sections can be delineated at the 4, the 8, and the 12. At 4:00, the hour hand has traveled past 4 of the 12 hours, or 4/12 of the whole circle. The fraction 4/12 can be reduced to ⅓. The clock 100 can then be used to answer a question such as which fraction is bigger, ¼ or ⅓? Since ¼ is positioned at 3:00, and ⅓ is positioned at 4:00, it is easily determined that ⅓ is greater than ¼. Then, using the clock 100, such questions as if one-third is 4 hours, how many hours is two-thirds? To quickly determine this, the time is just doubled—4 hours become 8 hours and ⅔ is at 8 hours, or 8:00. Then, which is bigger, ⅔ or ¾? From the clock 100 it is easily determined that ⅔ is at 8:00, and ¾ is at 9:00, so ¾ is bigger.

Another analysis that can be performed using the clock 100 is accomplished by dividing the thirds into halves again. This results in lines that point to the 2, 4, 6, 8, 10 and 12 (all the even numbers on the clock). The fractions at 4:00, 6:00, 8:00, and 12:00 have already been discussed. For the 2 and 10 positions on the clock 100, 2:00 is 2 out of 12 hours around the whole circle, or 2/12, and 10:00 is 10 out of 12 hours around the whole circle or 10/12.

As another example, the clock 100, in conjunction with reducing fractions, can be used for mathematical and other comparisons. For example, by reducing 2/12 to ⅙, it is easily determined that the 2:00 position is ⅙ of the way around the whole circle. This information can then be used to compare fractions, such as determining that ¼ is larger than ⅙ because the ¼ is at the 3:00 position and the ⅙ is at the 2:00 position. As another example, it is easily determined that ⅚ is larger than ¾ because the ⅚ is at 10:00 and the ¾ is at 9:00.

The clock 100 can also be used as a circular number line. For example, if ¼ is 3 hours, and ⅓ is 4 hours, using the clock 100 it is easily determined that ¼ plus ⅓ is 7/12 because 3 hours plus 4 hours is equal to 7 hours. As another example, knowing that ⅙ is 2:00, or 2 hours, then it is easily determined that ⅙+¼ is simply 2 hours plus 3 hours which is equal to 5 hours or 5/12, so ⅙+¼= 5/12. Similarly, it is easily determined that ⅙+⅓ is equivalent to 2 hours plus 4 hours which is 6 hours or ½. So ⅙+⅓=½.

While it is typical to envision one-half on a clock as a line between 12 and 6, in reality, ½ can be envisioned as simply a line through the center of the clock 100 in any direction. Therefore, considering ¼, or 3:00, it is easily determined that ¼+½ is ¾ by extending a straight line from ¼ or 3:00 to ¾ or 9:00. Similarly, it is easily determined that ⅙+½ is ⅔ since ⅙ is at 2:00, and a straight line from 2:00 across the clock is 8:00, or ⅔. The clock 100 can also be used in a similar manner for subtracting one fraction from another.

or other fractions such as ⅕ and 1/10 that are not on the clock 100, the minutes of the clock 100 can be used. Knowing that ½ is 30 minutes, ¼ is 15 minutes, and 1/12 is 5 minutes, that it takes the minute hand 60 minutes to travel all the way around the clock, and that 60 minutes can be divided into 10 parts so that each section is 6 minutes-that is 1/10 is 6 minutes, these other fractions can be manipulated. For example, by doubling 1/10 to get 2/10, or ⅕, then it is determined that ⅕ is at 12 minutes. Similarly, tripling 1/10 gives 3/10 or 18 minutes (3 sections of 6 minutes).

Using the information that ⅕ is at 12 minutes, then ⅖ is simply two sections of 12 minutes, or 24 minutes, which is just one minute less than 5/12, which is at 25 minutes. Consequently, it is easily determined that 5/12 is bigger than ⅖ since 5/12 is at 25 minutes and ⅖ is at 24 minutes.

The clock 100 can also be used to calculate eighths. Since the quarter is at 3:00, the quarter can be divided by two to get an eighth. An eighth on the clock 100 is then at half of 3:00 or 1:30, or exactly half-way between 12:00 and 3:00. So ⅛ is at the 1:30 position, or one and a half hours, and every eighth is one and a half hours. Then to add an ⅛, add one and a half hours to a clock position. For example, adding ⅛ to 2/8 results in ⅜ which is at 4:30 or four and a half hours. Similarly, adding ⅛ to 4/8 results in ⅝ at 7:30, and adding ⅛ to 6/8 (or ¾ at 9:00) results in ⅞ at 10:30.

The clock 100 can be used in any 12-based calculation. For example, conversions involving feet and inches and conversions involving years and months. The clock 100 can be used to convert inches into a fraction of a foot, or vice-versa. The clock 100 simply needs to be pictured as a 12-inch ruler bent into a circle. Therefore, 6 inches, like 6:00, is a half of a foot. This concept can be expanded so that any length in feet can be worked with. For example, to divide 2 feet into 3 segments, the clock 100 can be used to determine that ⅓ of a foot is 4 inches, and two times four is 8 inches, so ⅓ of 2 feet is 8 inches.

When dealing with months and years, each month can be an hour on the clock 100 (though it must be kept in mind that not all months have exactly the same number of days). Notwithstanding, the clock 100 can still be used to visualize progress through the year, like a 12-month circular calendar. Knowing that each month is 1/12 of a year, it is easily determined that 2 months is 2/12 or ⅙ of a year.

FIG. 1 further illustrates that the clock 100 can be used to work with decimals and percentages. For example, the clock 100, which has already been divided into 12 sections, can also be divided into 100 sections to give a clock 100 in decimal form. When the 12 section clock and the 100 section clock are superimposed, other comparisons can be performed. As noted, when the clock 100 is divided into 60 minutes, fifths and tenths are generated. Since fifths and tenths convert easily to decimals, they are also easily found on the clock by examining the minutes on the clock.

One-tenth of 60 minutes is 6 minutes, so every 6 minutes is another tenth, or another 0.1. For hundredths instead of tenths, each 6 minutes would be 0.10. The minutes can be used to find and compare fractions and decimals whose denominators are 5 and 10 with many other fractions. For example, ⅕ of 12 may be hard to figure out, but ⅕ of 60 is easier—⅕ of 60 is 12. As another example, since the ¼ position at 3:00 is 15 minutes, and ⅕ is 12 minutes, ¼ is larger than ⅕. The decimal for ⅕ is 0.20 and it is also at 12 minutes on the clock. The decimal for ¼ is 0.25, at 15 minutes on the clock. While is it not difficult to determine which decimal number is larger than another decimal number, when one amount is given in a fraction form, and another amount is given in decimal form, the clock 100 can be used to compare the two.

The two clock hands of clock 100 are lines that meet in the center of a circular map, and the space between these two lines is measured in degrees. Dividing the 360 degrees of clock 100 into 12 hours results in each hour of the clock being equal to 30 degrees. Angles can be estimated by using the clock 100. For example, if an angle looks like it is equivalent to the angle between 12:00 and 1:00, then the angle measures about 30 degrees. Other angles can be estimated using the clock 100.

In one embodiment, clock 100 includes a compass notation, and can be used to teach students how to use a compass. The eight points in a circle are the cardinal points (the main points) on a compass. They are extremely important degrees used for navigation. Four of the cardinal points are North, South, East, and West. When the needle on a compass is pointing straight North (N), that point is 0°, Due East (E) is 90°, South (S) is 180°, and West (W) is 270°. For the second set of cardinal points, Northeast (NE) is at 45°—that's 1:30 on the clock, or ⅛ of a circle, Southeast (SE) is at 135°—that's 4:30 on the clock, or ⅜ of a circle, Southwest (SW) is at 225°—that's 7:30 on the clock, or ⅝ of a circle, and Northwest (NW) is at 315°—that's 10:30 on the clock, or ⅞ of a circle.

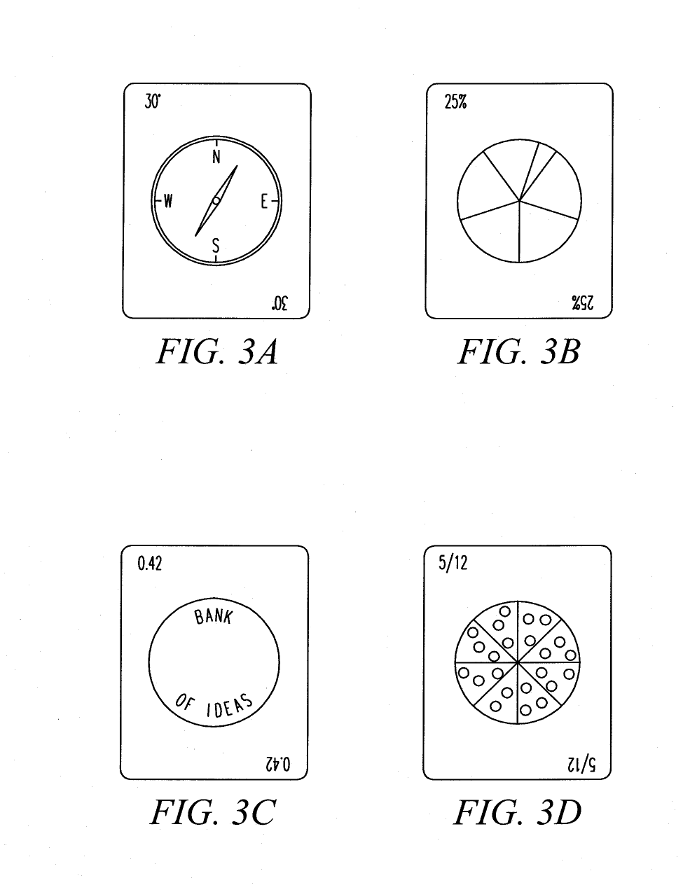

In an embodiment, the clock 100 can be embodied on and used in connection with a deck of specialty playing cards. Examples of such playing cards are illustrated in FIGS. 3A-3D. For example, in a deck of 52 cards, each “suit” displays a set of 12 or 13 equivalent facts as might have been displayed on the clock rings. With equivalent values, such as fractions, decimals, percentages, and degrees of a circle, these cards may be used to play virtually any conventional card game, such as Solitaire, Go Fish, War, Poker, Free Cell, etc., by matching or ranking them in order of their value.

The clock 100 could also be embodied in a computer readable medium. Such a computer readable medium could include instructions for providing a plurality of concentric perimeters, circles, or rings. In one embodiment, the instructions allow an instructor to configure the clock and cards in order to emphasize, for example, fractions, history, geometry, or the like. The concentric circles could includes several perimeters in which a first perimeter included a clock, a second perimeter included a plurality of fractions, a third perimeter included a plurality of decimal numbers, a fourth perimeter included a plurality of percentages, and a fifth perimeter included a plurality of degree magnitudes. As noted above, an example of such an embodiment is illustrated in FIG. 1. As also indicated above, the plurality of concentric perimeters could be configured to permit conversions and mathematical operations using one or more of a fraction, a decimal number, a percentage, and a degree magnitude. It should be noted that the terms first, second, third, fourth, fifth, etc. are used simply to differentiate one ring from another, and are not meant to necessarily indicate the position of any such ring on the clock 100. The specialty playing cards as illustrated in FIGS. 3A-3D could also be embodied in a computer readable medium.

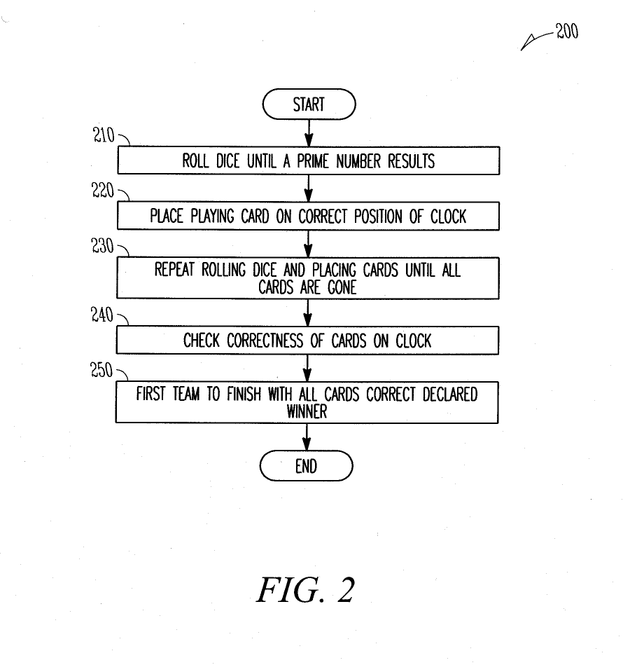

In another embodiment, the clock 100 can be imprinted on a medium such as a cloth or cardboard-type medium. A plurality of playing cards (See FIGS. 3A-3D) can be provided for use in conjunction with the clock 100. Each card can have imprinted thereon a “suit” including either a fraction, a decimal number, a percentage, or a degree magnitude, thereby matching the positions of the clock. One or more dice can also be provided, and the clock 100, the playing cards, and the dice can be used in an instructional game such as a relay race. A flowchart of an example relay race 200 is illustrated in FIG. 2.

For the relay race, the cloth or cardboard with the clock on it can be placed on a table. Each team would have its own table, clock, playing cards, and dice. The cards can be placed upside down on the table. A mark is made a certain distance from each table, for example 15-20 feet from the table. In one version, as indicated at 210 in FIG. 2, a player from each team rolls two dice, and keeps rolling the dice until a prime number (2, 3, 5, 7, or 11) results. Upon attaining a prime number, the player runs to the table, picks a card, and places it on the correct position on the clock (220). For example, if the card is a 42%, the player should place that card at the 5:00 position. The player then returns to the line, and at 230, the next player rolls the dice until he or she gets a prime number. Each player can rearrange any of the cards on the clock to correct any errors. When all the cards are placed on the clock, then at 240, the entire team runs to the table, checks the clock, and signals when it is done. After every team finishes, the clock and cards of the first team to finish are checked for correctness. If their cards are correct, they are the winners. If not, the cards and clock of the second team to finish are checked. This continues until a correct clock and cards are verified at 250.

The playing cards can also be provided separately from the clock 100. The playing cards, as noted, can include one of four “suits”—a fraction, a decimal number, a percentage, or a degree magnitude. More specifically, a first portion of the cards can include a fraction, a second portion of the cards can include a decimal number, a third portion of the cards can include a percentage, and a fourth portion of the cards can include a degree magnitude. The first portion, the second portion, the third portion, and the fourth portion each comprise 25% of the total number of cards. These cards can be used in various card games, or variations thereof, such as War, Free Cell, Poker, Go Fish, and Solitaire.

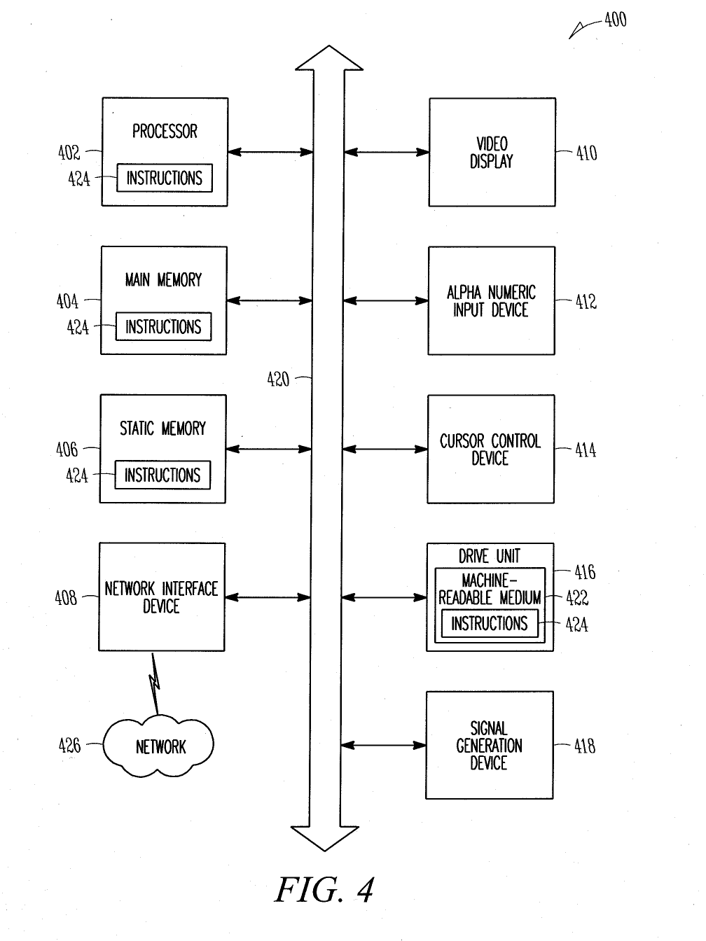

FIG. 4 is a diagrammatic representation of a machine in an example form of a computer system within which a set of instructions, for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Further with reference to FIG. 4, the example computer system 400 includes a processor 402 (e.g., a central processing unit (CPU), a graphics processing unit (GPU) or both), a main memory 404 and a static memory 406, which communicate with each other via a bus 420. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 408.

Still further with reference to FIG. 4, the disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media. The software 424 may further be transmitted or received over a network 426 via the network interface device 408 utilizing any one of a number of well-known transfer protocols (e.g., HTTP).

Lastly with reference to FIG. 4, while the machine-readable medium 422 is shown in the example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of an example embodiment, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules can be implemented as hardware circuitry, optical components, single or multi-processor circuits, memory circuits, software program modules and objects, firmware, and combinations thereof, as appropriate for particular implementations of various embodiments.

Thus, an example system, method and machine readable medium for teaching fractions, decimals, percentages, degrees, and other related facts have been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. An apparatus comprising:
a first perimeter comprising a facsimile of a clock; and
one or more perimeters, each perimeter comprising one or more of a plurality of fractions, a plurality of decimal numbers, a plurality of percentages, and a plurality of degree magnitudes.

2. The apparatus of claim 1, wherein the first perimeter comprises a 12:00 position, the 12:00 position associated with one or more of a fraction of n/n, a decimal number 1.00, a percentage of 100%, and a 360 degree magnitude.

3. The apparatus of claim 1, wherein the first perimeter comprises a 1:00 position, the 1:00 position associated with one or more of a fraction of 1/12, a decimal number 0.08, a percentage of 8%, and a 30 degree magnitude.

4. The apparatus of claim 1, wherein the first perimeter comprises a 2:00 position, the 2:00 position associated with one or more of a fraction of ⅙, a decimal number 0.17, a percentage of 17%, and a 60 degree magnitude.

5. The apparatus of claim 1, wherein the first perimeter comprises a 3:00 position, the 3:00 position associated with one or more of a fraction of ¼, a decimal number 0.25, a percentage of 25%, and a 90 degree magnitude.

6. The apparatus of claim 1, wherein the first perimeter comprises a 4:00 position, the 4:00 position associated with one or more of a fraction of ⅓, a decimal number 0.33, a percentage of 33%, and a 120 degree magnitude.

7. The apparatus of claim 1, wherein the first perimeter comprises a 5:00 position, the 5:00 position associated with one or more of a fraction of 5/12, a decimal number 0.42, a percentage of 42%, and a 150 degree magnitude.

8. The apparatus of claim 1, wherein the first perimeter comprises a 6:00 position, the 6:00 position associated with one or more of a fraction of ½, a decimal number 0.50, a percentage of 50%, and a 180 degree magnitude.

9. The apparatus of claim 1, wherein the first perimeter comprises a 7:00 position, the 7:00 position associated with one or more of a fraction of 7/12, a decimal number 0.58, a percentage of 58%, and a 210 degree magnitude.

10. The apparatus of claim 1, wherein the first perimeter comprises an 8:00 position, the 8:00 position associated with one or more of a fraction of ⅔, a decimal number 0.67, a percentage of 67%, and a 240 degree magnitude.

11. The apparatus of claim 1, wherein the first perimeter comprises a 9:00 position, the 9:00 position associated with one or more of a fraction of ¾, a decimal number 0.75, a percentage of 75%, and a 270 degree magnitude.

12. The apparatus of claim 1, wherein the first perimeter comprises a 10:00 position, the 10:00 position associated with one or more of a fraction of ⅚, a decimal number 0.83, a percentage of 83%, and a 300 degree magnitude.

13. The apparatus of claim 1, wherein the first perimeter comprises an 11:00 position, the 11:00 position associated with one or more of a fraction 11/12, a decimal number 0.92, a percentage of 92%, and a 330 degree magnitude.

14. The apparatus of claim 1, wherein the first perimeter comprises a 1:30 position, the 1:30 position associated with one or more of a fraction of ⅛, a decimal number 0.125, a percentage of 12.5%, and a 45 degree magnitude.

15. The apparatus of claim 1, wherein the first perimeter comprises a 4:30 position, the 4:30 position associated with one or more of a fraction of ⅜, a decimal number 0.375, a percentage of 37.5%, and a 135 degree magnitude.

16. The apparatus of claim 1, wherein the first perimeter comprises a 7:30 position, the 7:30 position associated with one or more of a fraction of ⅝, a decimal number 0.625, a percentage of 62.5%, and a 225 degree magnitude.

17. The apparatus of claim 1, wherein the first perimeter comprises a 10:30 position, the 10:30 position associated with one or more of a fraction of ⅞, a decimal number 0.875, a percentage of 87.5%, and a 315 degree magnitude.

18. The apparatus of claim 1, wherein the first perimeter and the one or more perimeters are concentric.

19. The apparatus of claim 1, wherein one or more portions of the clock comprise one or more colors.

20. The apparatus of claim 1, wherein the clock, the fractions, the decimal numbers, the percentages, and the degree magnitudes are configured so as to permit conversion between the fractions, the decimal numbers, the percentages, and the degree magnitudes.

21. The apparatus of claim 1, wherein the clock, the fractions, the decimal numbers, the percentages, and the degree magnitudes are configured so as to permit mathematical operations among the fractions, the decimal numbers, the percentages, and the degree magnitudes.

22. The apparatus of claim 21, wherein the mathematical operations include addition, subtraction, multiplication, division, and modular arithmetic.

23. The apparatus of claim 1, comprising one or more additional perimeters relating to one or more of music, historical facts, months, literary information, languages, temperature, currency, radians, trigonometric functions, modular arithmetic, factorials, square roots, exponentials, and logarithms.

24. The apparatus of claim 1, wherein the apparatus is attached to a clock.

25. An apparatus comprising two or more perimeters, the two or more perimeters including a facsimile of a clock and information relating to one or more of fractions, decimal numbers, percentages, degrees, music, historical facts, months, literary information, languages, temperature, currency, radians, trigonometric functions, modular arithmetic, factorials, square roots, and exponentials.

26. The apparatus of claim 25, wherein the two or more perimeters are concentric.

27. A computer readable medium comprising instructions for executing a process comprising:
displaying a plurality of concentric perimeters, wherein
a first perimeter comprises a facsimile of a clock;
a second perimeter comprises a plurality of fractions;
a third perimeter comprises a plurality of decimal numbers;
a fourth perimeter comprises a plurality of percentages; and
a fifth perimeter comprises a plurality of degree magnitudes; and
further wherein
the plurality of concentric perimeters is configured to permit conversions and mathematical operations using one or more of a fraction, a decimal number, a percentage, and a degree magnitude.

28. An apparatus comprising:
a medium comprising a facsimile of a clock face, the medium including one or more of a fraction, a decimal number, a percentage, and a degree;
a plurality of cards, each card including a fraction, a decimal number, a percentage, or a degree magnitude; and
one or more dice;
wherein the medium, the plurality of cards, and the one or more dice are configured such that one or more cards are placed on the medium as a function of a roll of the one or more dice.

29. The apparatus of claim 28, wherein the medium comprises a fabric or a fiber-based medium.

30. An apparatus comprising:
a plurality of playing cards, wherein each of the playing cards comprises either a fraction, a decimal number, a percentage, or a degree magnitude;
wherein a first portion of the cards comprise a fraction, a second portion of the cards comprise a decimal number, a third portion of the cards comprise a percentage, and a fourth portion of the cards comprise a degree magnitude; and
wherein the first portion, the second portion, the third portion, and the fourth portion each comprise substantially 25% of the total number of cards.

31. The apparatus of claim 30, wherein the plurality of cards are configured for use in connection with one or more of a Poker card game, a Go Fish card game, a War card game, a Free Cell card game, and a Solitaire card game.

32. A method comprising:
rolling one or more dice; and
placing a card on a facsimile of a clock, the card including a value of a fraction, a decimal number, a percentage, or a degree.

33. The method of claim 32, wherein the rolling the one or more dice is repeated until it results in a prime number.

34. The method of claim 32, comprising:
selecting two or more teams to roll the one or more dice and place one or more playing cards on the clock facsimile; and
repeating the rolling and the placing of the playing cards until all the cards have been placed on the clock facsimile.

35. An apparatus comprising one or more perimeters, the one or more perimeters including one or more of a plurality of fractions, a plurality of decimal numbers, a plurality of percentages, a plurality of degrees, a plurality of radians, a plurality of trigonometric functions, a plurality of numbers relating to modular arithmetic, a plurality of factorials, a plurality of square roots, a plurality of exponentials, a plurality of logarithms, information relating to music, information relating to historical facts, a plurality of months, literary information, information relating to languages, a plurality of temperatures, and information relating to currency;
wherein the one or more perimeters are configured for attachment to a clock.

36. An apparatus comprising:
a first segment relating to one or more positions of a clock;
a second segment relating to a plurality of fractions;
a third segment relating to plurality of decimal numbers;
a fourth segment relating to a plurality of percentages; and
a fifth segment relating to a plurality of degree magnitudes.
